(19) United States
(12) Patent Application Publication
(10) Pub. No.: US 2007/0223478 A1
(43) Pub. Date: Sep. 27, 2007

(54) First-arrival learning method, repeater, and computer product

(75) Inventors: Kazuto Nishimura, Kawasaki (JP); Jun Tanaka, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/472,117

(22) Filed: Jun. 21, 2006

(30) Foreign Application Priority Data
Mar. 22, 2006 (JP) 2006-079364

(51) Int. Cl. H04L 12/56

(52) U.S. Cl. 370/392

(57) ABSTRACT

When a packet arrives, a packet processing unit judges whether coincident information is present in an identity information table. When no coincident information is present, the packet processing unit registers the entire packet, a hash value of the entire packet, a predetermined part of the packet, or a hash value of the predetermined part of the packet. In addition, the packet processing unit performs identity judgment for the packet based on the information registered in the identity information table.

### BACKGROUND OF THE INVENTION

1. Field of the Invention

The present invention relates to a first-arrival learning method, a repeater, and a program for the repeater for learning that, in a repeater that performs routing control on a network on which a packet is distributed, a port that first receives one of identical packets sent to a plurality of ports by another repeater is a first arrival port, and, more particularly to a first-arrival learning method, a repeater, and a program for the repeater that can accurately perform judgment on an identical packet and can perform routing control for a packet even when existing repeaters are mixed on a network.

2. Description of the Related Art

Due to the spread of the wide area Ethernet (registered trademark) service, the Ethernet (registered trademark) technology is increasingly applied to the wide area networks such as the metro area network (MAN) and the wide area network (WAN). In recent years, the Layer 2 (L2) switch has been attracting attentions as a repeater that relays data packets delivered on such wide area networks.

The L2 switch is less expensive than a router and has significant advantages. For example, the L2 can use any kind of upper layer protocols. Thus, it is considered that the L2 switch will be further spread in future. However, the L2 switch has been originally designed as a repeater for the local area network (LAN) and is not devised on the assumption that the L2 switch is applied to the wide area networks such as the MAN.

For example, when routing control is performed to deliver a packet on an optimum route in a communication network formed by connecting a plurality of L2 switches to one another, in some cases, it is impossible to select the optimum route depending on a physical constitution of a network even if the spanning tree protocol (STP) or the multi-protocol STP (MSTP), which is an extended method of the STP, defined as a network redundancy method is used. In such a case, network loads concentrate on a specific route.

When the STP or the MSTP is used, a maximum number of hops is limited to about twenty because of the limitation of the STP. Thus, there is also a problem concerning scalability in that it is impossible to construct a network including a larger number of hops.

Consequently, as a method of taking care of the above problems of the STP or the MSTP, a so-called first-arrival-port learning method (hereinafter, “first-arrival learning method”) is proposed. Specifically, in the first-arrival learning method, in a repeater provided in a certain node, when identical packets simultaneously delivered on a network by another repeater arrives at a plurality of ports of the repeater, it is learned that a port that receives one of the identical packets first is a first arrival port. The identical packet that arrives at the first arrival port is flooded to the other ports and the identical packets that arrive at the other ports are discarded.

In the first-arrival learning method, accuracy of judgment on whether packets received from the ports are identical packets is very important. This is because, if packets that are not identical packets are judged as identical packets, later arriving packets are discarded to cause a packet loss. If packets that are identical packets are judged as not identical, redundant packets are delivered on the network.

Therefore, various technologies for judging identity of packets in the first-arrival learning method are proposed. For example, Japanese Patent Application Laid-Open No. H3-162035 discloses a first-arrival learning method of judging that packets having an identical sender address and an identical destination address received within a predetermined time are judged as identical packets. Japanese Patent Application Laid-Open No. H6-37764 discloses a first-arrival learning method in which a repeater set in an entrance node of a network adds an identification tag for packet identification to respective packets and respective repeaters on the network performs judgment on identity of the packets using the identification tag.

However, in the technology disclosed in Japanese Patent Application Laid-Open No. H3-162035, all the packets received within the predetermined time and having identical sender address and identical destination address are judged as identical packets and packets other than the identical packets are discarded which causes a temporary interruption in the communication.

The technology disclosed in Japanese Patent Application Laid-Open No. H6-37764 uses an original identification tag. Thus, it is necessary to construct a network only from repeaters that can recognize the identification tag. In other words, existing repeaters can not be used.

Therefore, there is a need to find a way to realize a first-arrival learning method that can accurately perform judgment on an identical packet and can perform routing control for a packet even when existing repeaters are mixed on a network and a repeater to which the first learning method is applied.

### SUMMARY OF THE INVENTION

It is an object of the present invention to at least partially solve the problems in the conventional technology.

According to an aspect of the present invention, a method that causes a repeater to perform routing control for a packet on a network and learn that a port that first receives one of identical packets sent to a plurality of routes by another repeater is a first arrival port includes storing packet information generated from contents of a received packet in a storing unit; and judging, based on the packet information stored in the storing unit, whether content of a later arriving packet that arrives after a first arriving packet is identical to content of the first arriving packet.

According to another aspect of the present invention, a repeater that performs routing control for a packet on a network and learns that a port that first receives one of identical packets sent to a plurality of routes by another repeater on the network is a first arrival port includes a storing unit that stores therein packet information generated from contents of a received packet; and a judging unit that judges, based on the packet information stored in the storing unit, whether content of a later arriving packet that arrives after a first arriving packet is identical to content of the first arriving packet.

According to still another aspect of the present invention, a computer-readable recording medium stores therein a computer program that causes a repeater to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a repeater according to an embodiment of the present invention;

FIG. 2 is a flowchart of a process performed by a packet processing unit;

FIG. 3 is an example of the contents of a MAC table;

FIG. 4 is an example of the contents of an identity information table in which entire packets are stored;

FIG. 5 is an example of the contents of an identity information table in which hash values are stored;

FIG. 6 is an example of the contents of an identity information table in which FCS's are stored;

FIG. 7 is a diagram for explaining drawbacks of a conventional STP;

FIG. 8 is a diagram for explaining drawbacks of a conventional MSTP;

FIG. 9 is a schematic diagram for explaining a first-arrival learning method according to the conventional technology; and

FIG. 10 is a schematic for explaining drawbacks of the first-arrival learning method according to the conventional technology.

### DETAILED DESCRIPTION OF THE PREFERRED EMBODIMENTS

Exemplary embodiments of the present invention are explained in detail below with reference to the accompanying drawings. In the following explanation, a first-arrival learning method according to the present invention is applied to a repeater.

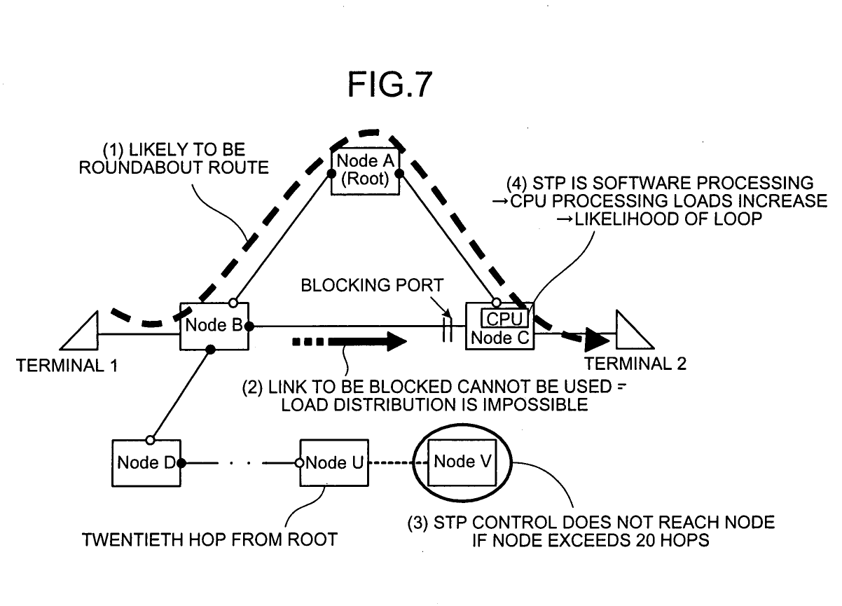

Prior to the explanation of the embodiments, to clarify characteristics of the first-arrival learning method according to the present invention, problems of the spanning tree protocol (STP), the multi-protocol STP (MSTP), and the first-arrival learning method according to the conventional technology are explained using FIGS. 7.to 10.

Drawbacks of the STP according to the conventional technology are explained using FIG. 7. FIG. 7 is a diagram for explaining the drawbacks of the STP according to the conventional technology. Nodes (a Node a, a Node B, etc.) shown in the figure are repeaters such as a layer 2 (L2) switch. The nodes perform routing control for packets exchanged between a terminal 1 and a terminal 2.

As shown in the figure, when a physical loop is present on a network, the STP forms a logical tree network on the network by logically performing block of ports and avoids the physical loop using the tree network.

However, when the STP is used, a packet can pass only on a logical tree. Thus, in some cases, the packet cannot pass on an optimum route (e.g., a route between the Node B and the Node C in FIG. 7 is the shortest). In other words, when the optimum route is closed by the block of ports, it is likely that the packet inevitably passes on a roundabout route (see (1) in FIG. 7).

Since the route between the Node B and the Node. C cannot be used at all, it is impossible to distribute network loads (see (2) in FIG. 7). Moreover, the STP has a limitation that STP control reaches up to only twentieth hop from a root note (see (3) in FIG. 7) so that larger networks can not be built. Since the STP is implemented in software processing., processing loads are applied on a CPU. When a failure occurs in the CPU, the STP does not normally operate to form a loop (see (4) in FIG. 7).

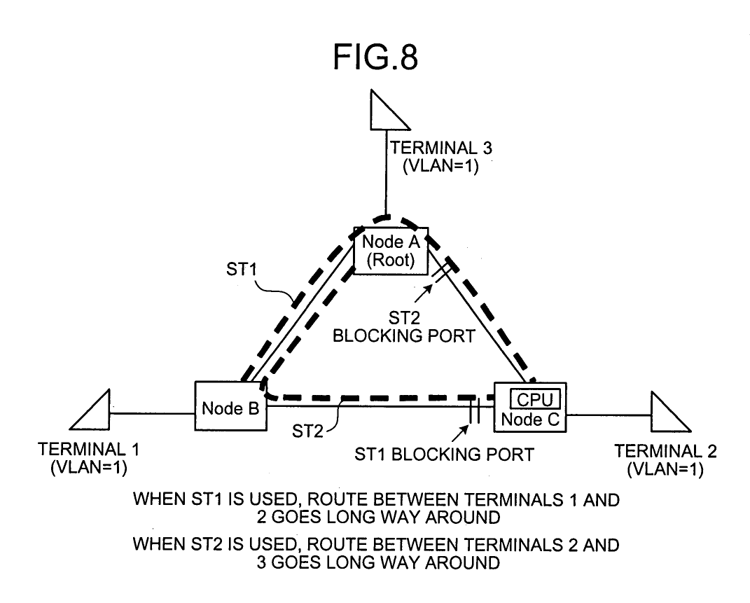

Drawbacks of the MSTP according to the conventional technology are explained using FIG. 8. FIG. 8 is a diagram for explaining the drawbacks of the MSTP according to the conventional technology. The MSTP is an extended method of the STP devised to solve the problems of the STP. The MSTP distributes network loads by forming a plurality of logical trees on a network (see ST1 and ST2 in FIG. 8) and changing a logical tree for each virtual LAN (VLAN).

However, as shown in FIG. 8, when there are three terminals belonging to an identical VLAN, any one of routes connecting terminals is not the shortest. In other words, a packet exchanged between the terminals cannot pass on an optimum route. For example, when the logical tree ST1 is used, a route between the terminal 1 and the terminal 2 goes the long way around. When the logical tree ST2 is used, a route between the terminal 2 and the terminal 3 goes the long way around.

In this way, the STP and the MSTP according to the conventional technique have limitations on selection of an optimum route. To solve the problems in these technologies, a packet control method called a “first-arrival learning method” is proposed.

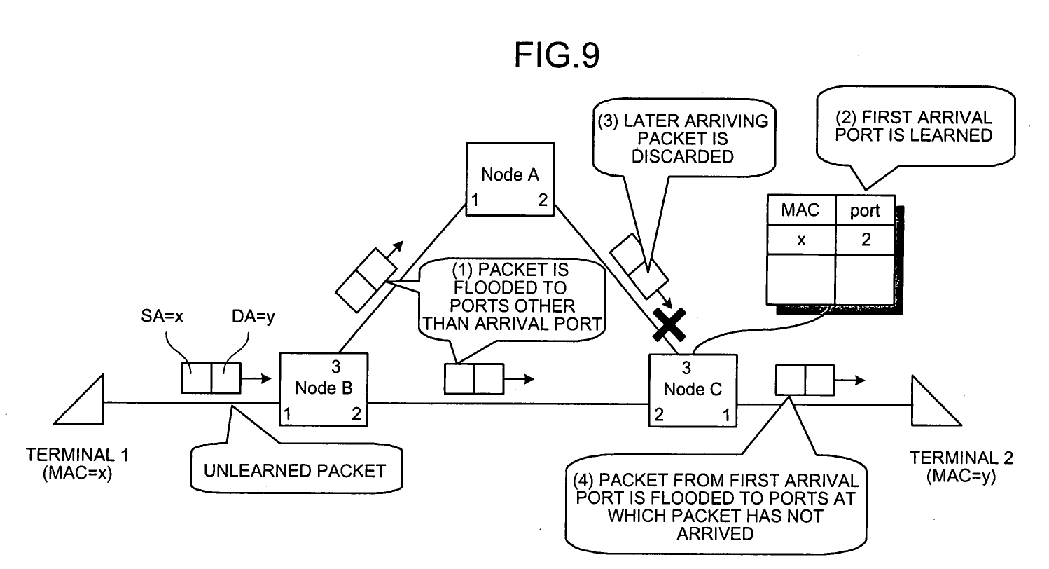

The first-arrival learning method according to the conventional technology is schematically explained using FIG. 9. FIG. 9 is a schematic diagram of the first-arrival learning method according to the conventional technology. As shown in the figure, in the first-arrival learning method, when a packet including an unlearned sender address arrives at a node, the packet is flooded to ports other than an arrival port (see (1) in FIG. 9) and the arrival port (a first arrival port) is learned together with the sender address (see (2) in FIG. 9).

Based on a result of the learning, later arriving packets arriving at the ports other than the first arrival port, which have content identical with that of the packet, are discarded (see (3) in FIG. 9). The packet arriving at the first arrival port is flooded to the other ports (see (4) in FIG. 9).

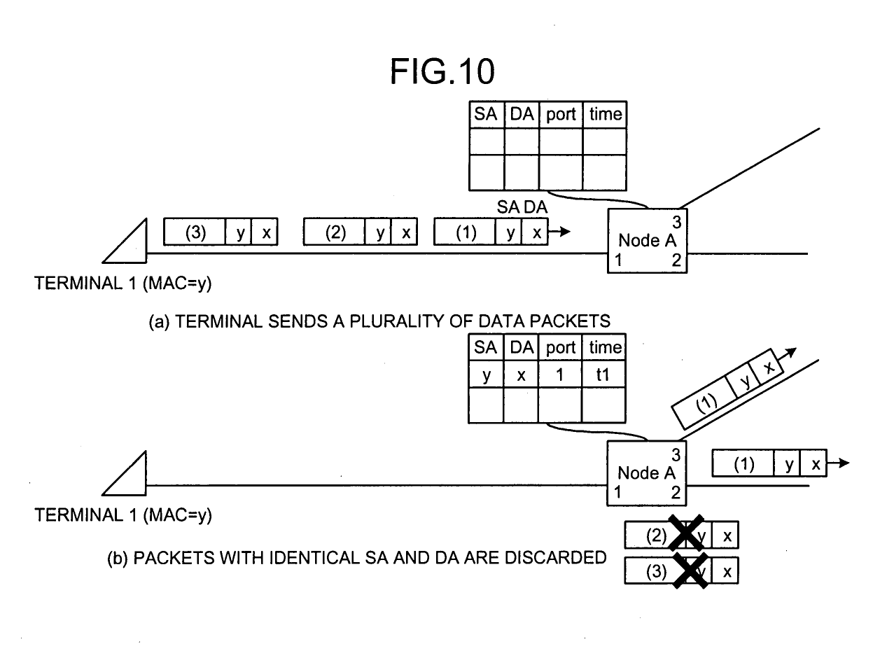

However, the first-arrival learning method according to the conventional technology has problems described below. Thus, when the first-arrival learning method is put to practical use, it is necessary to solve the problems. The problems of the first-arrival learning method according to the conventional technology are explained using FIG. 10. FIG. 10 is a diagram for explaining the problems of the first-arrival learning method according to the conventional technology. The problems of the technology disclosed in Japanese Patent Application Laid-Open No. H3-162035 are shown in FIG. 10.

As shown in (a) in FIG. 10, a terminal sends a plurality of data packets. In this case, data packets having an identical sender address (SA) and an identical destination address (DA) but having different contents (see (1), (2), and (3) in (a) in FIG. 10) are sent from a terminal 1.

However, a node A (a repeater to which the first-arrival learning method is applied) recognizes the packets having the identical SA and DA as identical packets. Thus, as shown in FIG. 10B, the node A discards the later arriving data packets (see (2) and (3) in (b) in FIG. 10). Moreover, in the technology disclosed in Japanese Patent Application Laid-Open No. H3-162035, a packet arriving at any one of the ports is discarded as long as the packet has the identical SA and DA. When later arriving packets are discarded in this way, a packet loss and a temporary communication interruption state are caused.

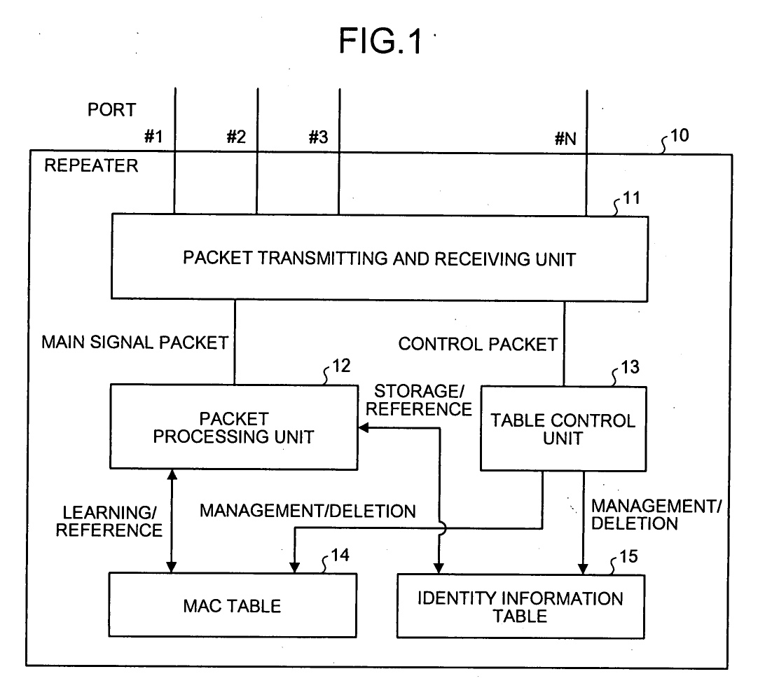

It is possible to take care of such a problem by adopting a method of surely performing the identity judgment for a packet (hereinafter, “method 1”) or a method of not discarding a packet arriving at a first arrival port (hereinafter, “method 2”). The first-arrival learning method according to an embodiment of the present invention proposes a detailed processing method of the method 1. The first-arrival learning method according to the embodiment is explained in detail below using FIGS. 1 to 6.

FIG. 1 is a block diagram of a repeater 10 to which the first-arrival learning method according to the embodiment is applied. The repeater 10 includes N ports, #1 to #N, a packet transmitting and receiving unit 11, a packet processing unit 12, a table control unit 13, a MAC table 14, and an identity information table 15.

The packet transmitting and receiving unit 11 is a processing unit that performs processing concerning transmission and reception processing such as encapsulation of packets exchanged via the respective ports. A data packet of a main signal is passed to the packet processing unit 12 via the packet transmitting and receiving unit 11. The packet transmitting and receiving unit 11 also performs processing for passing a control packet to the table control unit 13.

The packet processing unit 12 is a processing unit that performs forwarding processing for packets and identity judgment processing among the packets. Specifically, when the packet processing unit 12 receives a packet, the packet processing unit 12 accesses the identity information table 15 and judges whether an identical packet has already arrived.

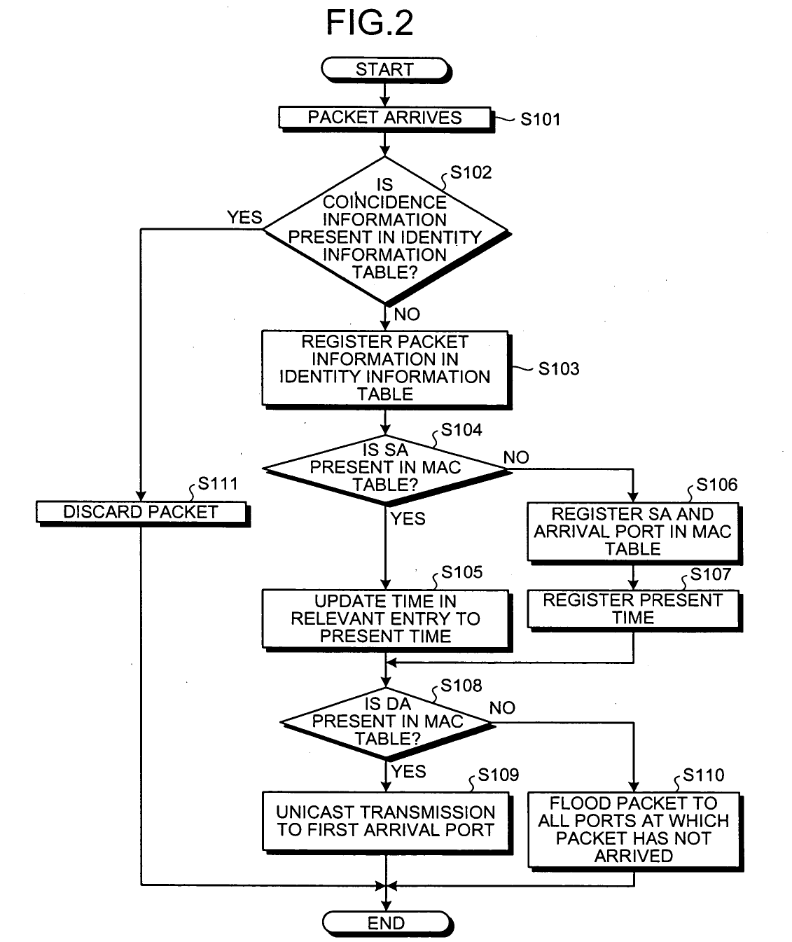

When it is judged that an identical packet has already arrived, the packet processing unit 12 regards the received packet anew as a later arriving packet and discards the packet. On the other hand, when it is judged that an identical packet has not arrived yet, the packet processing unit 12 registers packet information concerning the packet received anew in the identity information table 15. A detailed processing procedure performed by the packet processing unit 12 is described later using FIG. 2.

The table control unit 13 is a processing unit that performs management and deletion processing for records in the MAC table 14 and the identity information table 15 based on the control packet received via the packet transmitting and receiving unit 11.

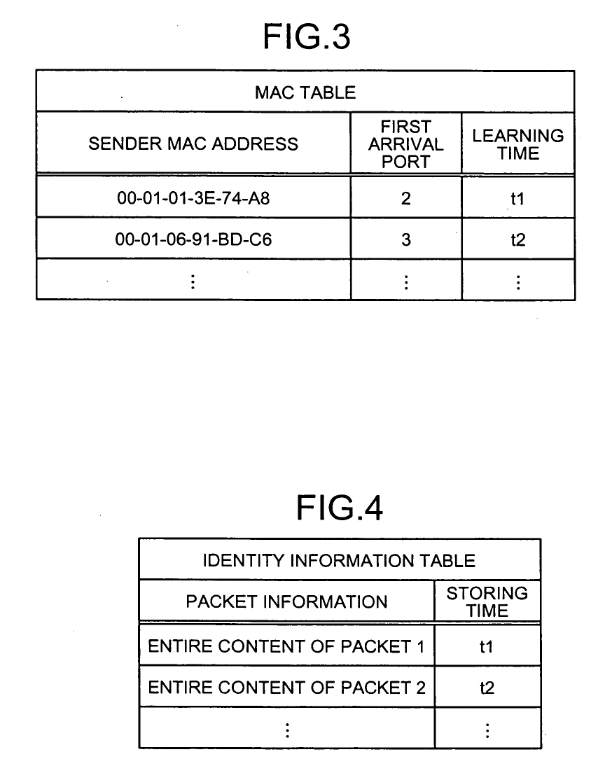

The MAC table 14 is a table for managing learning information concerning a sender of a first arriving packet. An example of the MAC table 14 is explained using FIG. 3. FIG. 3 is an example of the contents of the MAC table 14. The MAC table 14 includes “sender MAC address” that uniquely identifies a sender of the first arriving packet, “first arrival port” that represents a port number of a port that receives the first arriving packet, and “learning time” that represents time when the first arriving packet is learned.

The identity information table 15 is a table for managing content itself of a first arriving packet or information obtained by processing the content of the first arriving packet to use the content or the information for identity judgment for the first arriving packet and a later arriving packet. The identity information table 15 includes items “packet information” that is information representing the content of the first arriving packet and “storing time” representing time when the packet information is stored. There are several variations of the information stored in the identity information table 15. The variations are explained using FIGS. 4 to 6.

FIG. 4 is a diagram of the identity information table 15 in which an entire packet is stored. As shown in the figure, entire content of each first arriving packet is stored in the item “packet information” and time when the entire content of the first arriving packet is stored is stored in the item “storing time”. In this way, a “packet itself” is held as packet information and identity judgment for an entire first arriving packet and an entire later arriving packet is performed. This makes it possible to reduce a packet misrecognition ratio to 0%.

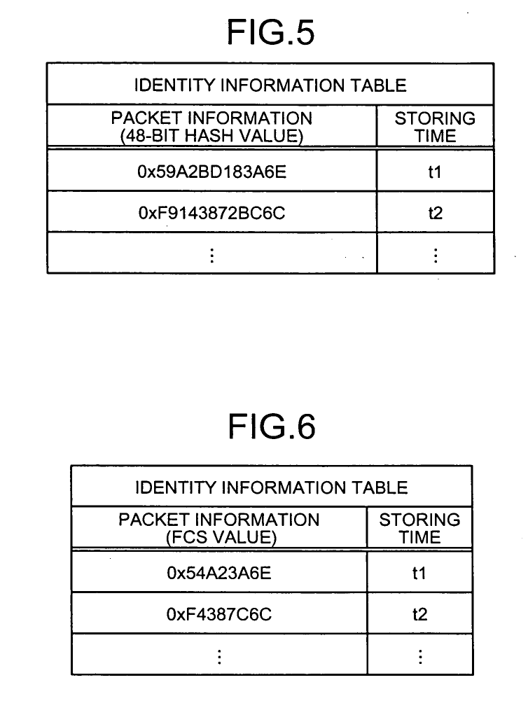

The method of holding entire content of a packet in the identity information table 15 and judging identity of the packet is an identity judging method with highest certainty. However, in this case, since the identity information table 15 has to hold the entire content of the packet, a memory capacity increases. Therefore, a method of holding information obtained by degrading the entire packet instead of holding the entire content of the packet is also conceivable. The identity information table 15 holding the information obtained by degrading the entire packets is explained using FIG. 5.

FIG. 5 is a diagram of the identity information table 15 in which a hash value is stored. As shown in the figure, in the item “packet information”, a hash value obtained by multiplying an entire first arriving packet by a hash function is stored. In FIG. 5, an entire packet is degraded to a 48-bit hash value. In this way, information obtained by degrading an entire packet is held instead of holding the entire packet. This makes it possible to reduce a memory capacity and perform sure identity judgment.

In FIG. 4, the entire packet is held in the identity information table 15. In FIG. 5, the hash value of the entire packet is held in the identity information table 15. When the entire packet is used in this way, it is possible to realize highest accuracy of the identity judgment. However, it is not always necessary to use the entire packet.

For example, an n-th bit to an m-th bit from the top of a packet may be held in the identity information table 15 and used for the identity judgment. A hash value obtained by multiplying the n-th bit to the m-th bit from the top of the packet by a hash function may be held in the identity information table 15 and used for the identity judgment.

When a predetermined part of a packet is held in the identity information table 15, a method of holding a specific field defined in advance of a packet format in the identity information table 15 is also conceivable. The identity information table 15 in which the specific field of the packet format is stored is explained using FIG. 6.

FIG. 6 is a diagram of the identity information table 15 in which a frame check sequence (FCS) is stored. The FCS is a 32-bit field added for transmission error detection of a frame in the Ethernet (registered trademark). The FCS indicates a cyclic redundancy code (CRC) value obtained by a generator polynomial. Since the FCS is a value obtained by degrading an entire packet, if the FCS is held in the identity information table 15 and used for identity judgment, it is possible to perform identity judgment based on a hash value without calculating a hash value using a hash function. An error misrecognition ratio is reduced to about 1/4.3 billionth when the FCS is used for the identity judgment.

A process performed by the packet processing unit 12 is explained using FIG. 2. FIG. 2 is a flowchart of the process performed by the packet processing unit 12. When a packet arrives (step S101), the packet processing unit 12 judges whether coincident information is present in the identity information table 15 (step S102). When no coincident information is present in the identity information table 15 (“No” at step S102), the packet processing unit 12 registers packet information concerning the packet at step S101 in the identity information table 15 (step S103). It is possible to select the packet information registered in the identity information table 15 at step S103 from the variations shown in FIGS. 4 to 6.

Subsequently, the packet processing unit 12 judges whether a sender address (SA) is present in the MAC table 14 (step S104). When an SA is present (“Yes” at step S104), the packet processing unit 12 updates time in a relevant entry to present time (step S105). When no SA is present (“No” at step S104), the packet processing unit 12 registers an SA and an arrival port in the MAC table 14 (step S106) and registers the present time (step S107).

The packet processing unit 12 judges whether a destination address (DA) is present in the MAC table 14 (step S108). When a DA is present (“Yes” at step S108), the packet processing unit 12 performs unicast transmission of the packet to a first arrival port (step S109) and ends the processing. On the other hand, when there is no DA (“No” at step S108), the packet processing unit 12 floods the packet to all ports at which the packet has not arrived (step S110) and ends the processing. When it is judged at step S102 that coincident information is present in the identity information table 15 (“Yes” at step S102), the packet processing unit 12 discards the packets (step S111) and, then, ends the processing.

As described above, according to this embodiment, when a packet arrives, the packet processing unit judges whether coincident information is present in the identity information table. When coincident information is not present, the packet processing unit registers the entire packet, a hash value of the entire packet, a predetermined part of the packet, or a hash value of the predetermined part of the packet in the identity information table. In addition, the packet processing unit performs identity judgment for the packet based on the information registered in the identity information table. Therefore, it is possible to accurately judge an identical packet and perform routing control for the packet even when existing repeaters are mixed on the network.

In the embodiment, the repeater realizing the present invention is explained in terms of functions. However, it is also possible to realize the functions of the repeater by causing a computer such as a personal computer or a workstation to execute computer programs.

It is possible to realize the various processing procedures described above by executing computer programs prepared in advance on the computer. It is possible to distribute the programs via a network such as the Internet. It is also possible to execute the computer programs by recording the computer programs in a computer readable recording medium such as a hard disk, a flexible disk (FD), a compact disk-read only memory (CD-ROM), a magneto-optical disk (MO), a digital versatile disk (DVD), or the like and reading out the programs from the recording medium with the computer.

According to the present invention, packet information generated based on a received packet is held and it is judged whether content of a later arriving packet is identical with content of a first arriving packet based on the packet information held. Thus, it is possible to accurately judge identical packets. The judgment on identity is performed without adding original information to the packet. Thus, there is an effect that it is possible to perform routing control for the packet even when existing repeaters are mixed on the network.

Moreover, information including the received packet itself is used as packet information. When the packet included in the packet information and a later arriving packet coincide with each other, it is judged that both the packets are identical packets. Thus, there is an effect that it is possible to reduce a packet misrecognition ratio in the identity judgment to 0%.

Furthermore, a hash value of a received packet itself is used as packet information. When this hash value and a hash value of a later arriving packet coincide with each other, it is judged that both the packets are identical packets. Thus, there is an effect that it is possible to control a memory area size for holding packet information.

Moreover, information on a predetermined part of a received packet is used as packet information. When the predetermined part included in the packet information and the predetermined part of a later arriving packet coincide with each other, it is judged that both the packets are identical packets. Thus, there is an effect that it is possible to control a memory area size for holding packet information while keeping the identity judgment accurate.

Furthermore, a hash value of a predetermined part of a received packet is used as packet information. When a hash value of the predetermined part and a hash value of the predetermined part of a later arriving packet coincide with each other, it is judged that both the packets are identical packets. Thus, there is an effect that it is possible to control a memory area size for holding packet information while keeping the identity judgment accurate and easily perform the complicated identity judgment.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method that causes a repeater to perform routing control for a packet on a network and learn that a port that first receives one of identical packets sent to a plurality of routes by another repeater is a first arrival port, the method comprising:
storing packet information generated from contents of a received packet in a storing unit; and
judging, based on the packet information stored in the storing unit, whether content of a later arriving packet that arrives after a first arriving packet is identical to content of the first arriving packet.

2. The method according to claim 1, wherein
the packet information includes the received packet itself, and
the judging includes judging, when the packet included in the packet information and the later arriving packet coincide with each other, that both the packets are identical packets.

3. The method according to claim 1, wherein
the packet information includes a hash value of the received packet, and
the judging unit judges, when the hash value included in the packet information and a hash value of the later arriving packet coincide with each other, that both the packets are identical packets.

4. The method according to claim 1, wherein
the packet information includes information on a predetermined part of the received packet, and
the judging unit judges, when the information on the predetermined part included in the packet information and the predetermined part of the later arriving packet coincide with each other, that both the packets are identical packets.

5. The method according to claim 1, wherein
the packet information includes a hash value of a predetermined part of the received packet, and
the judging unit judges, when the hash value of the predetermined part included in the packet information and a hash value of the predetermined part of a later arriving packet coincide with each other, that both the packets are identical packets.

6. A repeater that performs routing control for a packet on a network and learns that a port that first receives one of identical packets sent to a plurality of routes by another repeater on the network is a first arrival port, the repeater comprising:
a storing unit that stores therein packet information generated from contents of a received packet; and
a judging unit that judges, based on the packet information stored in the storing unit, whether content of a later arriving packet that arrives after a first arriving packet is identical to content of the first arriving packet.

7. The repeater according to claim 6, wherein
the packet information includes the received packet itself, and
the judging unit judges, when the packet included in the packet information and the later arriving packet coincide with each other, that both the packets are identical packets.

8. The repeater according to claim 6, wherein
the packet information includes a hash value of the received packet, and
the judging unit judges, when the hash value included in the packet information and a hash value of the later arriving packet coincide with each other, that both the packets are identical packets.

9. The repeater according to claim 6, wherein
the packet information includes information on a predetermined part of the received packet, and
the judging unit judges, when the information on the predetermined part included in the packet information and the predetermined part of the later arriving packet coincide with each other, that both the packets are identical packets.

10. The repeater according to claim 6, wherein
the packet information includes a hash value of a predetermined part of the received packet, and
the judging unit judges, when the hash value of the predetermined part included in the packet information and a hash value of the predetermined part of a later arriving packet coincide with each other, that both the packets are identical packets.

11. A computer-readable recording medium that stores therein a computer program that causes a repeater to perform routing control for a packet on a network and learn that a port that first receives one of identical packets sent to a plurality of routes by another repeater is a first arrival port, the computer program causing the repeater to execute:
storing packet information generated from contents of a received packet in a storing unit; and
judging, based on the packet information stored in the storing unit, whether content of a later arriving packet that arrives after a first arriving packet is identical to content of the first arriving packet.

12. The computer-readable recording medium according to claim 11, wherein
the packet information includes the received packet itself, and
the judging includes judging, when the packet included in the packet information and the later arriving packet coincide with each other, that both the packets are identical packets.

13. The computer-readable recording medium according to claim 11, wherein
the packet information includes a hash value of the received packet, and
the judging unit judges, when the hash value included in the packet information and a hash value of the later arriving packet coincide with each other, that both the packets are identical packets.

14. The computer-readable recording medium according to claim 11, wherein
the packet information includes information on a predetermined part of the received packet, and
the judging unit judges, when the information on the predetermined part included in the packet information and the predetermined part of the later arriving packet coincide with each other, that both the packets are identical packets.

15. The computer-readable recording medium according to claim 11, wherein
the packet information includes a hash value of a predetermined part of the received packet, and
the judging unit judges, when the hash value of the predetermined part included in the packet information and a hash value of the predetermined part of a later arriving packet coincide with each other, that both the packets are identical packets.
